(19) United States
(12) Patent Application Publication
(10) Pub. No.: US 2025/0160570 A1
(43) Pub. Date: May 22, 2025

(54) FRY PORTIONING BASKET

(71) Applicant: Yum Connect, LLC, Louisville, KY (US)

(72) Inventors: Christopher Garcia, Corona, CA (US); Joaquin Soto, Menifee, CA (US)

(73) Assignee: Yum Connect, LLC, Louisville, KY (US)

(21) Appl. No.: 18/949,848

(22) Filed: Nov. 15, 2024

Related U.S. Application Data
(60) Provisional application No. 63/600,435, filed on Nov. 17, 2023.

(51) Int. Cl. A47J 37/12

(52) U.S. Cl. CPC A47J 37/1295

(57) ABSTRACT

The present disclosure relates to a fry portioning basket. The fry portioning basket includes a frame having a first side, a second side, a front, a rear side, and a bottom side. The frame defines a cavity and has frame height defined as a first distance between the bottom side and a top rim of the frame. The fry portioning basket includes one or more dividers positioned within the cavity and extending from the bottom between the first side and the second side of the frame. The one or more dividers have a divider height defined as a second distance from a top of the one or more dividers and the bottom side of the frame. The divider height is less than the frame height. The fry portioning basket also includes a handle extending adjacent the rear side.

### CROSS-REFERENCE TO RELATED APPLICATION

This application claims the benefit of and priority to U.S. Provisional Application No. 63/600,435, filed Nov. 17, 2023, which is incorporated herein by reference in its entirety and for all purposes.

### TECHNICAL FIELD

The present disclosure relates to food preparation equipment and, more specifically, to a basket (e.g., container, holder, storage and transporter) that may be used in the preparation of various food objects.

### BACKGROUND

Food may be prepared using various systems and techniques. Certain food items may be fried by placing the food into a wire basket that is submerged into cooking oil heated to a cooking temperature.

### SUMMARY

One embodiment of the present disclosure relates to a fry portioning basket. The fry portioning basket includes a frame having a first side, a second side, a front, a rear side, and a bottom side. The frame defines a cavity and has frame height defined as a first distance between the bottom side and a top rim of the frame. The fry portioning basket includes one or more dividers positioned within the cavity and extending from the bottom between the first side and the second side of the frame. The one or more dividers have a divider height defined as a second distance from a top of the one or more dividers and the bottom side of the frame. The divider height is less than the frame height. The fry portioning basket also includes a handle extending adjacent the rear side.

Another embodiment of the present disclosure relates to a fry portioning basket. The fry portioning basket includes a wire mesh frame having a first side, a second side, a front side, a rear side, and a bottom side. The wire mesh frame defines a cavity and includes a frame height defined as a first distance between the bottom and a top rim of the wire mesh frame. The two or more dividers are positioned within the cavity and extend between the first side and the second side. Each of the two or more dividers have a divider height defined as a second distance from the bottom side of the wire mesh frame and a top of one of the two or more dividers, wherein the divider height is less than the frame height, and wherein the two or more dividers are spaced apart such that a third distance between the two or more dividers is substantially equal. The fry portioning basket includes a handle extending adjacent the rear side.

Still another embodiment of the present disclosure relates to a method of manufacturing a fry portioning basket. The method includes providing a frame having a first side, a second side, a front, a rear side, and a bottom side, the frame defining a cavity and having a frame height defined as a first distance between the bottom side and a top rim of the frame. The method includes coupling one or more dividers within the cavity such that the dividers extend from the bottom side between the first side and the second side of the frame, the one or more dividers having a divider height defined as a second distance from a top of the one or more dividers and the bottom side of the frame. The divider height is less than the frame height. The method further includes coupling a handle to the frame such that the handle extends away from the rear side of the frame.

These and other features will be more clearly understood from the following detailed description taken in conjunction with the accompanying drawings and claims. Numerous specific details are provided to impart a thorough understanding of embodiments of the subject matter of the present disclosure. The described features of the subject matter of the present disclosure may be combined in any suitable manner in one or more embodiments and/or implementations. In this regard, one or more features of an aspect of the invention may be combined with one or more features of a different aspect of the invention. Moreover, additional features may be recognized in certain embodiments and/or implementations that may not be present in all embodiments or implementations.

### BRIEF DESCRIPTION OF THE DRAWINGS

FIG. 1 is a perspective view of a fry portioning basket, according to an exemplary embodiment.

FIG. 2 is a bottom perspective view of the fry portioning basket of FIG. 1 and food items, according to an exemplary embodiment.

FIG. 3 is a sectional side view of the fry portioning basket of FIGS. 1-2, according to an exemplary embodiment.

FIG. 4 is a top perspective view of a fry portioning basket having one divider, according to another exemplary embodiment.

### DETAILED DESCRIPTION

It should be understood at the outset that although illustrative implementations of one or more embodiments are illustrated below, the disclosed systems and methods may be implemented using any number of techniques, whether currently known or not yet in existence. The disclosure should in no way be limited to the illustrative implementations, drawings, and techniques illustrated below, but may be modified within the scope of the appended claims along with their full scope of equivalents.

Referring generally to the Figures, a basket (e.g., container, holder, storage device, etc.) that may be used with food (e.g., in the preparation of food objects) is disclosed herein. In one exemplary use, the basket may be used in the preparation of fries and, in turn, be referred to as a fry basket herein. The fry basket may include at least one divider with each at least one divider having a divider height that is shorter relative to a height of the fry basket. For example, in some kitchens, such as individual, restaurant, or other kitchens, food items may be pre-cooked or fried in large quantities and later divided into individual servings. In this case, the food items, such as but not limited to French fries, are cooked or fried in large batches and then placed under a food warmer until the food items are ordered by a customer. Once ordered by the customer, the pre-prepared fried food items are portioned into individual servings for the customer. However, the pre-prepared food item may stay under the food warmer for an extended period of time and be less desirable if not served promptly. In contrast, other kitchens may wait to fry the food items, again such as French fries, until the food items are ordered by the customer in order to avoid the food quality concerns described above. While frying food contemporaneously may have benefits, such a process may present challenges. For example, it may be difficult for preparers to determine the correct portion size to place in fry baskets when preparing only a single or perhaps a few servings. The preparer may inadvertently place too many or too few of the food items in the fry basket, which results in undersized servings, or portions of the food item, or food waste. Technically and beneficially, the dividers of the fry basket described herein create sub-cavities within the fry basket, and each of the sub-cavities represent a portion-sized serving of a food item. Advantageously, this enables users to quickly fill each sub-cavity with food items up to the divider height, allowing the user to quickly prepare generally consistent portions for frying and reducing waste (e.g., from overfilling).

Another current problem is that fried food items may clump together or fry unevenly when the food item is not able to disperse or separate adequately within cooking oil during frying. Technically and beneficially, once a portion of the fry basket is submerged in oil, the food items are allowed to rise or “float out” past the at least one divider. This reduces clumping and allows for more even frying of food items relative to a fry basket in which dividers extend the entire height or nearly the entire height of the fry basket. These and other features and benefits are described more fully herein below.

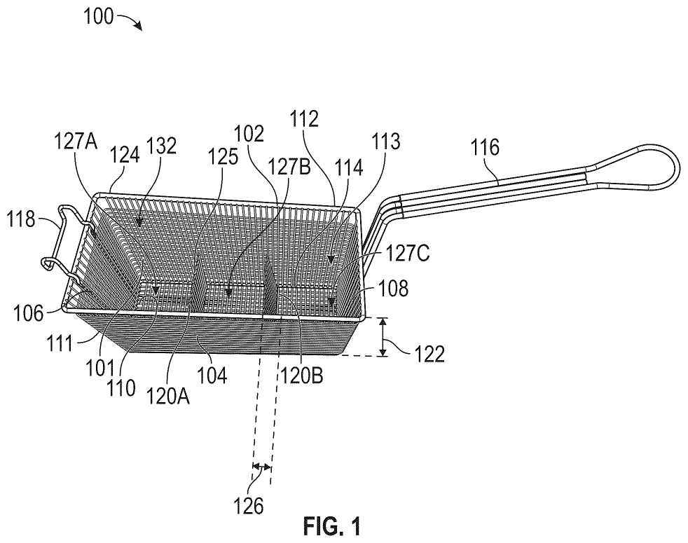

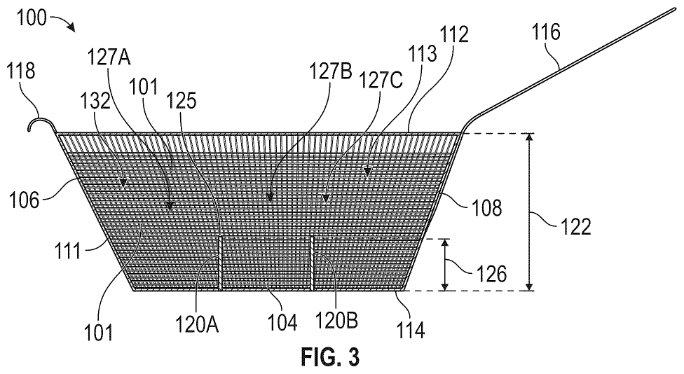

FIGS. 1-3 illustrate a basket for use with food (e.g., food preparation), shown as a fry portioning basket 100, according to an embodiment of the present disclosure. The fry portioning basket 100 includes walls, shown as a wire mesh 101 that forms a first side 102, a second side 104, a front side 106, a rear side 108, and a bottom side 110. The first side 102, the second side 104, the front side 106, the rear side 108, and the bottom side 110 of wire mesh 101 comprises a frame 111 that defines a cavity 113 (e.g., a receptacle, etc.) for receiving food items to be fried within the fry portioning basket 100. The fry portioning basket 100 may include upper and lower support bars 112 and 114 that provide for attachment of the wire mesh 101 and structural support of the fry portioning basket 100. More or fewer support bars 112 and 114, which may be provided in other locations for structural support, may be used in other embodiments. The fry portioning basket 100 also includes a handle 116 attached adjacent the rear side 108 of the frame 111. In some embodiments, the fry portioning basket 100 may further include a hook 118 adjacent the front side 106 of the frame 111 for attachment to a fryer and/or engagement with a fryer frame during cooking. The hook 118 may be variously configured depending on the configuration of the fryer where the fry portioning basket 100 is employed, or the hook 118 may be omitted.

The fry portioning basket 100 also includes dividers 120A and 120B. While only two (2) dividers are shown, more or fewer dividers may be provided in other embodiments. The dividers 120A and 120B are structured as wire mesh walls that are shown to extend vertically from the bottom side 110 and between the first side 102 and second side 104. In other embodiments, the dividers 120A and 120B may extend between the front side 106 and the rear side 108. Thus, the dividers 120A and 120B are from the wire mesh 101. In other embodiments, the dividers 120A and 120B may be not integral with the wire mesh 101 and, in turn, be formed from other materials (e.g., solid metal that may or may not have openings to enable material to flow therethrough such as cooking oil). In this alternative embodiment, the dividers 120A and 120B may be coupled to the wire mesh 101 (e.g., via one or more fasteners, a joining process such as welding, etc.).

As shown in FIGS. 1-3, the dividers 120A and 120B extend substantially vertically from the bottom side 110 (e.g., +/−10°-20° from vertical). The fry portioning basket 100 generally has an overall basket height 122 defined as the distance between a top rim 124 and the bottom side 110 of the fry portioning basket 100. As shown in FIGS. 1-3, the dividers 120A and 120B extend vertically within the fry portioning basket 100 a divider height 126, which is a distance between the bottom side 110 of the frame 111 to a top 125 of the dividers 120A and 120B. In the embodiment depicted, the divider height 126 is less than the overall basket height 122. In some embodiments, the divider height 126 may be about between one-eighth to about seven-eighths the height of the overall basket height 122, or about between one-quarter to about three-quarters the height of the overall basket height 122, while in still other embodiments the divider height 126 may be about between one-third to about two-thirds the height of the overall basket height 122. For example, in one embodiment, the overall basket height 122 is between about five to six inches (5″-6″) high, and more specifically about five and three-quarters inches (5¾″) high, while the divider heights 126 are between about one to two inches (1″-2″) high, and more specifically about (1¾″) high. However other heights and proportional dimensions of the overall basket height 122 and the divider heights 126 may be used when given the considerations discussed herein.

According to one embodiment, the dividers 120A and 120B of the fry portioning basket 100 may be sized based on the desired or predetermined serving size of the food items to be prepared. In this embodiment, the dividers 120A and 120B divide the lower portion of the basket into three (3) sub-cavities 127A-C within the fry portioning basket 100. In other embodiments, more or fewer dividers may be included.

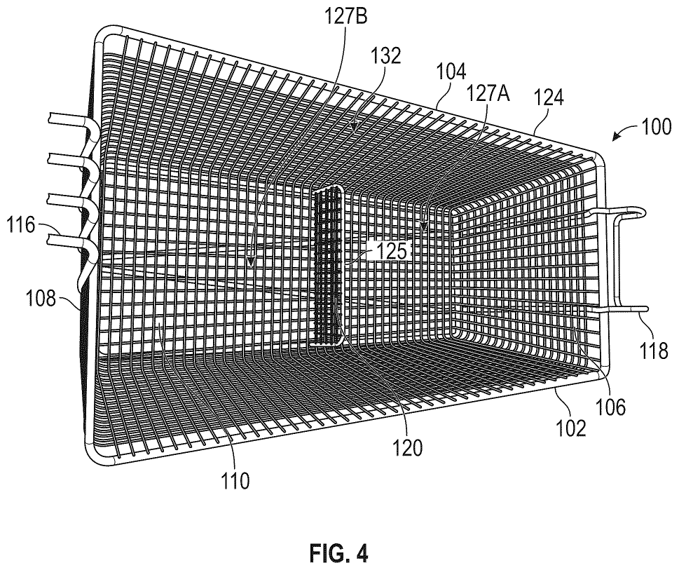

As shown in FIG. 4, the fry portioning basket 100 may include a single divider 120, in some embodiments. The single divider 120 may be positioned at or near the center of the bottom side 110, extending between the first side 102 and the second side 104, such that two equally or nearly equally sized sub-cavities 127A and 127B are formed (longitudinal length and width equivalence or near equivalence). In other examples, the single divider 120 may be positioned such that one sub-cavity is larger (longitudinal length wise) than the other sub-cavity to accommodate varied food item portion sizes (e.g., such that sub-cavity 124A is larger than sub-cavity 127B, or vice-versa). For example the sub-cavity 127A defined between the divider 120 the front side 106 may correspond to a small food item size, whereas the sub-cavity 127B defined between the divider 120 and the rear side 108 may correspond to a large food item size.

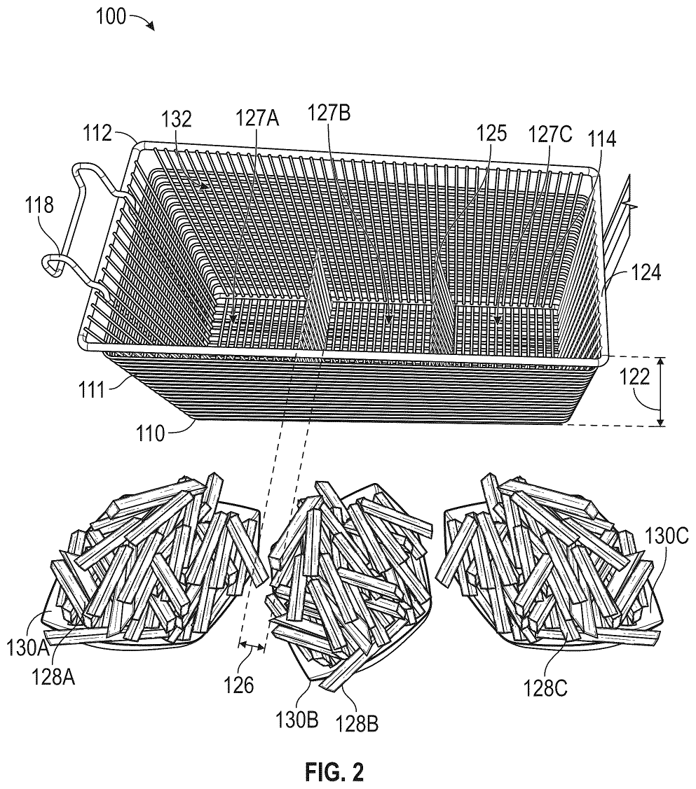

FIG. 2 also illustrates three servings 128A-C of the food items shown portioned into containers 130A-C, respectively. As can be seen, the divider height 126 of the dividers 120A and 120B are sized such that the space or area within each of the sub-cavities 127A-C is generally equal to the overall size of the each serving 128A-C of the food items to be fried. This allows the preparer to readily determine the amount of food items to load into each of the sub-cavities 127A-C in order to prepare the correct serving size of the food item. For example, when a single serving is ordered by a customer, the preparer fills or loads one of the sub-cavities, for example the sub-cavity 127A, with the food items to the top 125 of the divider 120A. In this manner, the preparer can readily, visually, identify the correct amount of the food items to load in the sub-cavity 127A to prepare a single serving.

In some examples, the dividers 120A and 120B (and 120) are integrally formed with the fry portioning basket 100. In other examples, the dividers 120A and 120B (and 120) are removably coupled to the fry portioning basket 100 (e.g., by slide in rails disposed along the overall basket height 122, by detachable clips or brackets, magnets, etc.). In such an example, the dividers 120A and 120B (and 120) may be removed for easier cleaning. Additionally, in examples where the dividers 120A and 120B (and 120) are removably coupled to the fry portioning basket 100, dividers 120A and 120B may be removed to added to change the number of sub-cavities 127A-C within the fry portioning basket 100. For example, removing one of the dividers 120A or 120B from the configuration shown in FIGS. 1-3 would result in the fry portioning basket 100 having a single divider 120, as depicted in FIG. 4.

Once a food item or food items are placed in one or more of the sub-cavities 127A-C and the fry portioning basket 100 is placed in the deep fryer, the fry portioning basket 100 is submerged in the cooking oil (e.g., such that the cooking oil reaches the top rim 124). In this position, the cooking oil extends above the divider height 126 of the dividers 120A and 120B, which allows the food item to rise or “float out” of the sub-cavities 127A-C. The fry portioning basket 100 includes an upper area 132 (e.g., an area generally between the top 125 of the dividers 120A, 120B and the top rim 124 of the frame 111). As the food items rise (e.g., float out, etc.) out of the sub-cavities 127A-C and into the upper area 132 of the fry portioning basket 100, the food items disperse and fry within the upper area 132. As such, the food items are allowed to move freely, separate, and float in the cooking oil within the upper area 132, thereby allowing for more even and uniform contact with the cooking oil during frying in the fry portioning basket 100. Accordingly, the divider height 126 of the dividers 120A and 120B may also be a factor of the food items so that the divider height 126 is of sufficient height to accommodate a desired serving size of the food item within the associated sub-cavity 127A-C, while also being sufficiently low enough to allow the food items to float out of the sub-cavity 127A-C and into the upper area 132 of the fry portioning basket 100 during frying.

Further, the dividers 120A and 120B may allow for easier distribution of the food items into the containers 130A-C after frying is completed. As discussed above, the food items may rise during frying. As the preparer lifts the fry portioning basket 100 with the food items out of the cooking oil, the food items may tend to settle generally proportionately back into the sub-cavities 127A-C. The preparer may additionally shake the fry portioning basket 100 lightly, to distribute the food items evenly within each sub-cavity 127A-C. The preparer may then arrange the containers 130A-C, such as on a table or surface, to align with the sub-cavities 127A-C within the containers 130A-C. The preparer may then tip the fry portioning basket 100 and pour out the food items into the aligned containers 130A-C, readily portioning out the appropriate serving size into the containers 130A-C. These and other embodiments and advantages will readily suggest themselves to one skilled in the art in view of the present disclosure.

While in some embodiments, the fry portioning basket 100 and components may be generally constructed using wire mesh 101, the various components described herein may be constructed of metal, such as stainless steel, plastic or polymeric materials, or any other materials or various combinations thereof. For example, the handle 116 may be constructed of stainless steel but may be partially coated with a material to allow a preparer to grasp or grip the handle 116 more securely, as well as, resisting the transfer of heat.

Although the dividers 120A and 120B are shown to be generally the same height, the dividers 120A and 120B may define different heights to accommodate varied portion sizes. For example, a first divider 120A may define a first height that is shorter than the height of a second divider 120B. The sub-cavity defined between the first divider 120A and the front side 106 may correspond to a small food item size, whereas the sub-cavity 127C defined between the second divider 120B and the rear side 108 may correspond to a large food item size. The sub-cavity 127B defined between the first divider 120A and the second divider 120B may also correspond to a small food item size. In this arrangement, the preparer can fill the sub-cavity 127B up to the height of the shorter first divider 120A. Aligning the fill level with the shorter first divider 120A helps maintain an even, level fill across the cavity, minimizing any slant or unevenness that could otherwise occur if the taller second divider 120B were used as the reference point. Although the example above describes the divider 120A as being shorter in height than the divider 120B, either divider may be shorter than the other (e.g., the divider 120B may be shorter in height than divider 120A).

Further, while the depicted embodiment shows the dividers, 120, 120A, 120B be oriented perpendicular or substantially perpendicular to a longitudinal length of the cavity of the fry portioning basket 100, in other embodiments, the dividers 120, 120A, 120B (or how many dividers provided) may be arranged parallel to a longitudinal length of the cavity of the fry portioning basket 100. In still other embodiments, at least one divider may be oriented along a longitudinal length of the basket while at least one other divider may be oriented perpendicular or substantially perpendicular to the longitudinal length of the fry portioning basket 100. This structure may create a grid (e.g., a 2×3 grid) structure of sub-cavities whereby each sub-cavity receives a portion of objects (e.g., food objects such as fries). All such variations are intended to fall within the spirit and scope of the present disclosure.

Based on the foregoing an example of manufacturing (e.g., producing, etc.) a fry portioning basket 100 may be described as follows. A provider or manufacturer may provide the frame 111. For example, the manufacturer/provider may assemble the frame 111 by coupling wire mesh 101 to the first side 102, the second side 104, the front side 106, and/or the rear side 108 (e.g., by welding, clips, adhesive, tension fit, etc.). The method of manufacturing the fry portioning basket 100 may include coupling one or more dividers 120, 120A, 120B to the bottom side 110 and one or more other sides 102, 104, 106, 108 (e.g., by slide in rails disposed along the overall basket height 122, by detachable clips or brackets, magnets, etc.). In this way, the dividers 120, 120A, 120B are attached to the interior of the fry portioning basket 100 such that the dividers create sub-cavities 127A-C within the cavity 113. The method of manufacturing may further include coupling the handle 116 to the frame such 111 that the handle 116 extends away from the rear side 108 of the frame (e.g., by welding, snap fit, screws, adhesive, etc.). In some examples, multiple handles 116 are coupled to the frame 111. For example, a first handle may be coupled to the first side 102 and a second handle may be coupled to the second side 106. In some examples, the method of manufacturing may include integrally forming the handle 116 with the frame 111 (e.g., by molding, etc.).

As utilized herein with respect to structural features (e.g., to describe shape, size, orientation, direction, relative position, etc.), the terms “approximately,” “about,” “substantially,” and similar terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

Although the description may describe a specific order of method steps, the order of such steps may differ from what is depicted and described, unless specified differently above. Also, two or more steps may be performed concurrently or with partial concurrence, unless specified differently above.

It is important to note that any element disclosed in one embodiment may be incorporated or utilized with any other embodiment disclosed herein. Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. A fry portioning basket, comprising:
a frame having a first side, a second side, a front, a rear side, and a bottom side, the frame defining a cavity and having a frame height defined as a first distance between the bottom side and a top rim of the frame;
one or more dividers positioned within the cavity and extending from the bottom side between the first side and the second side of the frame, the one or more dividers having a divider height defined as a second distance from a top of the one or more dividers and the bottom side of the frame, wherein the divider height is less than the frame height; and
a handle extending adjacent the rear side.

2. The fry portioning basket of claim 1, wherein a sub-cavity within the cavity of the frame is defined between the top of the one or more dividers and the bottom side of the frame, and between a first side of one of the one or more dividers and the front of the frame, and between the first side and the second side of the frame, and wherein the sub-cavity is sized to accommodate a serving of a food item.

3. The fry portioning basket of claim 2, wherein an upper area within the cavity of the frame is between the top of the one or more dividers and the top rim of the frame and between the first side and the second side and front and back of the frame, and wherein the upper area is sized to allow food items to float out of the sub-cavity when the fry portioning basket is at least partially submerged in cooking oil.

4. The fry portioning basket of claim 2, wherein the one or more dividers are removably coupled to the frame.

5. The fry portioning basket of claim 4, wherein the one or more dividers include a first divider and a second divider, and wherein the first divider or the second divider are configured to be removed to change the size of the sub-cavity.

6. The fry portioning basket of claim 1, wherein the one or more dividers include a first divider and a second divider, the first divider having a first divider height and the second divider having a second divider height, and wherein the first divider height is different from the second divider height.

7. The fry portioning basket of claim 1, wherein the divider height is further defined as being between one-quarter and three-quarters a height of the frame height.

8. The fry portioning basket of claim 1, wherein the divider height is further defined as being between one-third and two-thirds a height of the frame height.

9. The fry portioning basket of claim 1, wherein the frame is constructed of wire mesh.

10. The fry portioning basket of claim 1, wherein the one or more dividers are constructed of wire mesh.

11. The fry portioning basket of claim 1, further comprising a hook coupled to the top rim of the frame and configured to engage a fryer.

12. A fry portioning basket, comprising:
a wire mesh frame having a first side, a second side, a front side, a rear side, and a bottom side, the wire mesh frame defining a cavity and having a frame height defined as a first distance between the bottom side and a top rim of the wire mesh frame;
two or more dividers positioned within the cavity and extending between the first side and the second side, each of the two or more dividers having a divider height defined as a second distance from the bottom side of the wire mesh frame and a top of one of the two or more dividers, wherein the divider height is less than the frame height, and wherein the two or more dividers are spaced apart such that a distance between the two or more dividers is substantially equal; and
a handle extending adjacent the rear side.

13. The fry portioning basket of claim 12, wherein a sub-cavity within the cavity of the wire mesh frame is defined as a space between the top of a first divider and the bottom side of the wire mesh frame, and between a first side of the first divider and the front side of the wire mesh frame, and between the first side and the second side of the wire mesh frame, and wherein the space of the sub-cavity is sized approximately to accommodate a serving of a food item.

14. The fry portioning basket of claim 13, wherein an upper area within the cavity of the wire mesh frame is defined as between the top of the first divider and the top rim of the wire mesh frame and between the first side and the second side and the front side and the rear side of the wire mesh frame, and wherein the upper area is sized to allow food items to float out of the sub-cavity when the fry portioning basket is at least partially submerged in cooking oil.

15. The fry portioning basket of claim 13, wherein the two or more dividers are removably coupled to the wire mesh frame.

16. The fry portioning basket of claim 15, wherein the two or more dividers include the first divider, a second divider, and a third divider, and wherein at least one of the first divider, the second divider, or the third divider are configured to be removed to change the size of the sub-cavity.

17. The fry portioning basket of claim 12, wherein the divider height is further defined as being between approximately one-quarter and approximately three-quarters a height of the frame height.

18. The fry portioning basket of claim 12, wherein the divider height is further defined as being between approximately one-third and approximately two-thirds a height of the frame height.

19. The fry portioning basket of claim 12, wherein the two or more dividers include a first divider, a second divider, and a third divider, the first divider having a first divider height, the second divider having a second divider height, and the third divider having a third divider height, and wherein the first divider height is different from at least one of the second divider height or the third divider height.

20. A method of manufacturing a fry portioning basket, comprising:
providing a frame having a first side, a second side, a front, a rear side, and a bottom side, the frame defining a cavity and having a frame height defined as a first distance between the bottom side and a top rim of the frame;
coupling one or more dividers within the cavity such that the dividers extend from the bottom side between the first side and the second side of the frame, the one or more dividers having a divider height defined as a second distance from a top of the one or more dividers and the bottom side of the frame, wherein the divider height is less than the frame height; and
coupling a handle to the frame such that the handle extends away from the rear side of the frame.
